(19) United States
(12) Patent Application Publication
(10) Pub. No.: US 2008/0159519 A1
(43) Pub. Date: Jul. 3, 2008

(54) Method and an associated system for instantaneously obtaining costumer consent in relation to the purchase of a good or service

(75) Inventors: Yvan Lovric, Lunel (FR); Gregory Blanchon, Montpellier (FR); Christophe Tourneret, Castelnauld-Le-Lez (FR)

Correspondence Address: COHEN PONTANI LIEBERMAN & PAVANE LLP, Suite 1210, 551 Fifth Avenue, New York, NY, 10176, US

(73) Assignee: France Telecom, Paris (FR)

(21) Appl. No.: 12/004,712

(22) Filed: Dec. 21, 2007

(30) Foreign Application Priority Data
Dec. 22, 2006 (FR) 0655901

(51) Int. Cl. H04M 3/00

(52) U.S. Cl. 379/265.09

(57) ABSTRACT

A method and an associated system for obtaining a consent from a customer (U) by means of an interactive voice server (3) following a telephone conversation between the customer (U) and a telesales advisor (A) of a call center to confirm a purchase by the customer. To this end, an interactive voice server (3) cooperates with a CTI server (7), a storage device (51), and a context memory (12).

### BACKGROUND OF THE INVENTION

The field of the invention is that of telecommunications services and the invention is more particularly concerned with integrating services in telephone call centers.

At present, the sale of goods or services via a call center must be the subject of a communication sent to the customer, who must confirm their purchase by returning the communication so that the sale can be considered to have been confirmed.

This obligation exists in certain countries such as France (Order No. 2005-648 of 6 Jun. 2005 article 1 I Journal Officiel, 7 Jun. 2005, coming into force 1 Dec. 2005, and Law No. 2004-575 of 21 Jun. 2004 article 24 Journal Officiel of 22 Jun. 2004 applying to sales initiated by an incoming call (for example set up by a customer to a call center by dialing “1014” on their telephone) or by an outgoing call (calls sent by a call center to a customer in the context of telesales or telemarketing campaigns)).

The obligation to have a written record to confirm the act of sale generates an additional cost for the call center operator and consequently a loss of revenue.

One solution used at present to confirm this type of sale entails sending the customer by post, email, or fax a communication summarizing the sale, for which the customer has previously given their verbal agreement to a telesales adviser, vendor, or agent of the call center, which communication must be returned by post, email, or fax, signed by the customer, to confirm that the sale took place.

A disadvantage of that solution is that it cannot obtain a consent enabling a customer's purchase to be confirmed quasi-instantaneously following a preliminary conversation with a telesales advisor during which the client placed an order. That solution limits the responsiveness of the customer and slows down the sale process. In fact, customers have time to change their mind between the moment of confirming an order for goods or services orally with the vendor and the time of receiving the communication relating to the order. What is more, that solution is laborious for the customer, who is obliged initially to wait for the communication and then to return it after signing it.

What is more, managing the sending and reception of communications is just as laborious for the call center, as well as costly. In fact, it requires the execution of a certain number of tasks such as generating a communication, placing the communication in an envelope and posting it, updating a database with the communication, receiving the communication and transferring it to the department concerned, processing the order, and updating the tracking database.

### OBJECT AND SUMMARY OF THE INVENTION

To alleviate those drawbacks, an aspect of the present invention is directed to a method of managing calls between a user of a terminal, an interactive voice server, and an agent of a computer-telephone interconnection (CTI) station via routing means in a telecommunications network. The agent obtains order information from the user relating to the purchase of a good or service during a call in progress previously set up during a step of connecting the user and the agent by the routing means.

A method according to an embodiment of the invention further includes:

a step of the routing means transferring the call in progress to connect the user with the interactive voice server, the transfer step including a sub-step of supplying order information to the interactive voice server;

a step of requesting consent to the purchase of said good or service, comprising:

a sub-step of the interactive voice server generating a consent request message as a function of the order information; and

a sub-step of the interactive voice server supplying said consent request message to the terminal of the user so that the purchase of said good or service is confirmed in the event of reception by the interactive voice server of a consent response message sent from the terminal in the event of a positive response by the user.

The disclosed method of the invention is a quick and simple way to obtain the consent of the user to the purchase of goods or services that the agent has previously selected with the user's agreement during a call. If the user accepts the order by sending a positive response to the interactive voice server, the purchase can advantageously be confirmed as soon as the positive response is received from the user. In this way, the user's purchase can be confirmed, avoiding the laborious process whereby the call center initially sends a communication to the user, who then has to send it back to the call center after signing it.

According to another feature of the invention, the method of the invention further includes a first storage step during which the conversation between the user and the agent is stored in a context memory.

The context memory advantageously constitutes an effective tool for tracking sales. It records a purchase/a sale in context. Thus it can store the conversation that enabled an agent to agree the sale/purchase of goods and/or services with a user in a preliminary conversation. Moreover, it provides a record of goods sold by each agent.

According to another feature of the invention, if there is no response or a negative response from the user to the consent request message, the call set up at the end of the transfer step between the interactive voice server and the user is automatically transferred to the CTI station of the agent to put the user in direct communication with the agent.

This automatic call transfer returns the user to direct and transparent communication with the agent. This feature is particularly advantageous in that it facilitates the confirmation of a purchase when confirmation has failed, for example because the user stopped the call in progress with the interactive voice server intentionally (for example on having second thoughts) or unintentionally (because of an error on the part of the user or any kind of technical problem).

According to another feature of the invention, the interactive voice server offers a plurality of predefined options that the user can select from their terminal to supply a response message to the message received from the interactive voice server during the consent request message sending step.

These options are provided so that the user can give their immediate consent by responding to the consent request message, thus enabling instantaneous confirmation of a purchase directly after placing an order with the agent.

According to a feature of the invention, during the sub-step of sending a consent request message, the interactive voice server reads the order information obtained during the attachment sub-step.

In this way, the interactive voice server reminds the user about the goods or services they have ordered and for which they are ready to give purchase consent.

Another aspect of the invention is directed to a system for managing calls between a user of a terminal, an interactive voice server, and an agent of a computer-telephone interconnection (CTI) station via routing means in a telecommunications network, wherein the agent obtains order information from the user relating to the purchase of a good or service during a call in progress previously set up by said routing means during a step of connecting the user and the agent.

The system of the invention further includes:

means for transferring the call in progress to connect the user and the interactive voice server;

means for supplying said order information to the interactive voice server;

means for requesting consent to the purchase of said good or service:

means for generating a consent request message as a function of the order information; and

means for supplying a consent request message to the terminal of the user so that the purchase of said good or service is confirmed on reception by the interactive voice server of a consent response message sent from the terminal if there is a positive response by the user.

According to another feature of the invention, the system of the invention further includes recording means for recording the conversation between the user and the agent.

According to another feature of the invention, the system includes routing means for automatically transferring the call set up between the interactive voice server and the user to the CTI station of the agent, to place the user in direct communication with the agent, if there is no response or a negative response from the user to the consent request message.

According to another feature of the invention, the system of the invention includes an interactive voice server including means for offering predefined options that the user is able to select from their terminal to supply a response message to the message received from the interactive voice server.

According to another feature of the invention, the interactive voice server includes means for sending the order information to the terminal of the user vocally.

Another aspect of the invention is directed to an interactive voice server comprising:
means for generating a consent request message as a function of order information received at said server relating to the purchase of a good or service by a user;
means for suppling said consent request message to the terminal of the user; and
means for confirming the purchase of said good or service on reception of a consent response message sent from the terminal.

### BRIEF DESCRIPTION OF THE DRAWINGS

FIG. 1 is a diagram showing the architecture of one embodiment of a system of the invention;

FIG. 2 is a diagram showing a CTI 100 pane available on a CTI station 4 in the context of the invention; and

FIG. 3 is a flowchart showing the principal steps of the call management method of the invention applied to the system from FIG. 1.

### DETAILED DESCRIPTION OF THE DRAWINGS

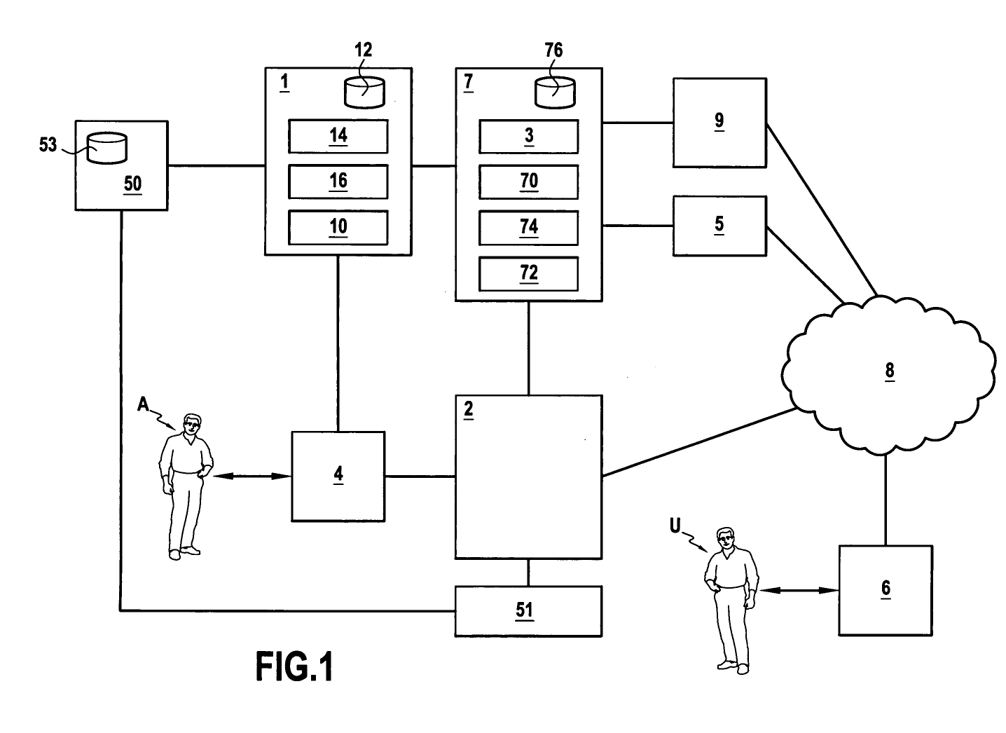

FIG. 1 is a diagram showing a system of the invention comprising an application server 1 able to communicate with an interactive voice server 3.

This system manages telephone calls via an intelligent network 8 between a telesales advisor or agent A logged onto a station 4 referred to as a CTI (computer-telephone interconnection) station located in a call center and a user U of a terminal 6.

The CTI station 4 is adapted to send and receive telephone calls over a switched telephone network (STN) and/or an IP network. This is known in the art. It can also manage data processing applications on an IP network. In practice, the CTI station 4 consists of a computer connected to a telephone.

The term “intelligent network” refers here to a network consisting of a switched telecommunications network (STN) connected to an IP network such as the Internet to carry conventional telephone calls and VoIP (Voice over IP) calls between the CTI station 4 of the telesales advisor A and the terminal 6 of the user U.

In this embodiment, the application server 1 is a Jonas or SUN type application engine with an interface for communicating with the CTI station 4 in accordance with the Transmission Control Protocol/Internet Protocol (TCP/IP), which is known in the art.

The interactive voice server 3 is implemented in a CTI server 7, for example by means of existing Genesys® software and more particularly its Genesys Interaction Routing Designer module. The CTI server 7 includes a universal routing service (URS) module 70 adapted to route telephone calls, in particular to the terminal 6 of the user U. The URS module provides an intelligent call routing service.

The CTI server 7 further includes an SIP server 74 adapted to communicate in accordance with the Session Initiation Protocol (SIP) known in the art with a VoIP gateway 9 placed at a stream break-in position between the CTI server 7 and the intelligent network 8.

The application server 1 controls a Java Servlet that implements a CTI pane management module 10 for managing a CTI pane 100 that is accessible from the CTI station 4 of the telesales advisor A. The CTI pane is a man/machine interface (MMI) enabling the user to interact over the telephone from their workstation.

In the situation considered here the CTI station 4 of the telesales advisor A includes a VoIP telephone able to communicate with the CTI server 7 via a TCP/IP-compatible Public Automatic Branch Exchange (PABX) 2.

However, if the “telephony” function of the CTI station 4 of the telesales advisor A were provided by a conventional telephone, the CTI server 7 includes an event translation (T-Server) module 72 for sending events to the application server 1 based on events received from the PABX 2, these events being recovered and processed by an event loop implemented in the application server 1.

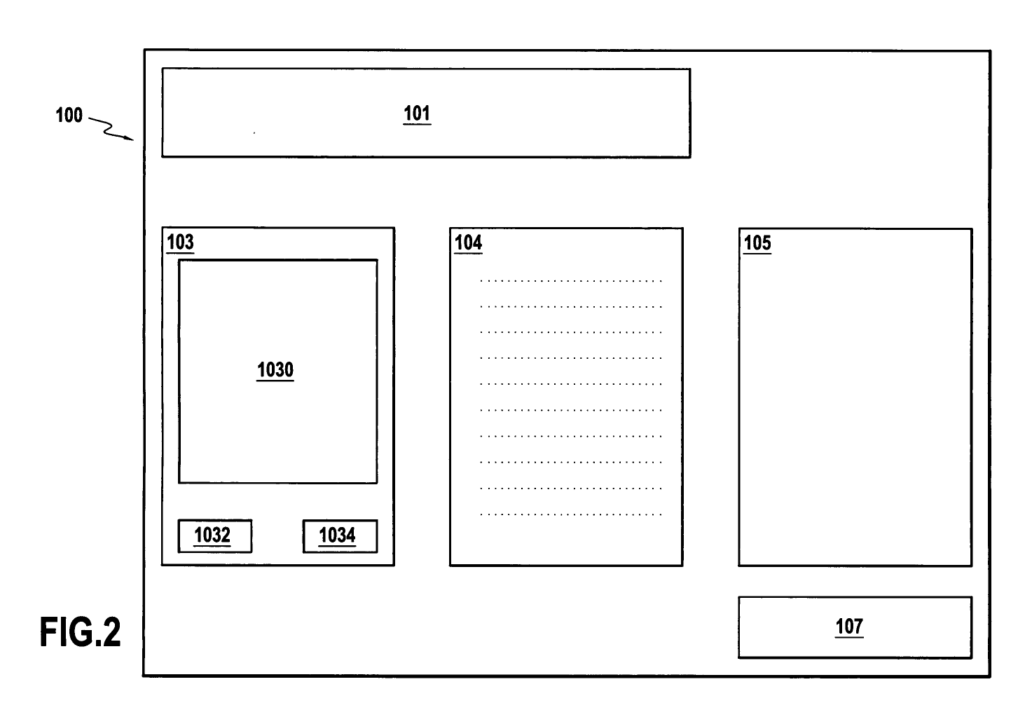

The telesales advisor A accesses the CTI pane 100 on their CTI station 4 by logging onto the application server 1. To this end, from their CTI station 4, the telesales advisor A enters into an address field 101 of a window of a web browser (for example Internet Explorer or Mozilla Firefox) the URL address corresponding to the application server 1, e.g. http://localhost:28080/procap04. The CTI pane 100 comprises three fields, for example, as shown in FIG. 2.

A first field 103 is for managing the connection to a call center telesales advisor management application that runs on the application server 1 and enables the telesales advisor A to enter their coordinates and to log on, for example by pressing a “Log On” button 1032, and to declare their availability to respond to a call, for example by pressing a “Go to Ready” button 1034.

A second field 104 displays information relating to a customer (or user) with whom the telesales advisor is communicating, such as their telephone number, name, forename, email address and postal address. Other personal information relating to the customer can also be included, such as their interests or the type of goods that they have previously purchased via the call center.

A third field 105 displays a list of goods available to purchase and which the telesales advisor can offer to the customer with whom they are communicating. This third field 105 enables the telesales advisor to view easily all of the goods available for sale and to select one or more of those goods by ticking a corresponding activation box provided for this purpose, all while communicating with the customer.

The CTI pane 100 also includes a “customer consent” button 107 which the telesales advisor presses when a sale has been agreed with the customer, or any other means providing this function, such as a touch-sensitive screen, in particular after selecting one or more of those goods from the list provided in the second field 104 as a function of the instructions of the customer, in order to obtain the consent of the customer to the purchase of the goods selected by the telesales advisor.

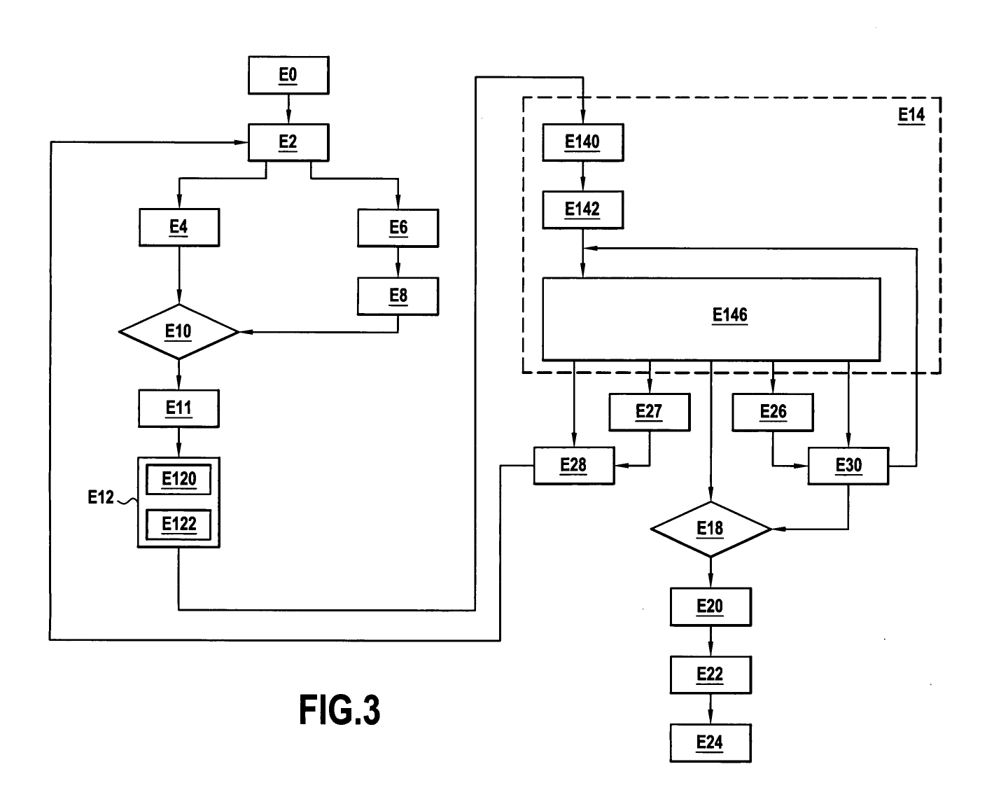

One embodiment of the method of the invention is described in detail next with reference to FIGS. 1, 2 and 3. In this embodiment it is considered that the user U of the terminal 6 wishes to contact a telesales advisor A to place an order and effect a purchase by telephone. It is assumed that before this the telesales advisor A has logged onto the telesales advisor management application (in particular a PRO-CAP application, where “PRO” signifies PROactive and “CAP” signifies Proactive Call Center (in French: Centre d'Appel Proactif) from their CTI station 4 and has declared their availability to take calls, for example by clicking on the “Go to Ready” button 1034 on the CTI pane 100).

It is assumed that the user U enters on their terminal 6 an incoming call number of the call center during an initial step E0. On reception of this incoming call, the system of the invention sets up a direct call between the user U and the telesales advisor A during a connection step E2 using mechanisms known to the person skilled in the art. Obviously the person skilled in the art also knows how to effect the connection step E2 in response to an outgoing call from the call center during which the telesales advisor A seeks to enter into communication with the user U.

A telephone conversation is established between the user U and the telesales advisor A from the moment at which the call is set up at the end of the connection step E2. During a first storage step E4, the telephone conversation is recorded in a recording database 53 on a recording server 50. Recording this telephone conversation provides a record that can advantageously be used during subsequent steps of the method of the invention. In particular, this record can provide elements of proof in the event of a purchase made by a user being contested.

To be more precise, during a first storage step E4, the application server 1 controls the recording server 50 which in turn controls a recording device 51 connected to the PABX 2 to record the conversation of the call in progress. In this embodiment of the invention, the first storage step E4 is initiated automatically on reception of an “EventEstablished” event indicating that the user and the telesales advisor are communicating. The event translation (T-Server) module 72 generates this event, which is sent to the application server 1 which then activates a “getTimeSlot” function which determines the channel on which the call between the user and the telesales advisor has been set up. Recording the conversation is launched in response to the application server 1 invoking a “StartEnreg” function on the channel previously identified.

Note that other parameters such as an identifier of the telesales advisor, the number of the caller, and a time parameter can also be sent to the “StartEnreg” function and used afterwards to provide a unique reference for the recording of the conversation.

As soon as the conversation with the user U begins, the telesales advisor A can obtain, during a customer information sheet retrieval step E6, information relating to the user U with whom they are currently communicating, so that the telesales advisor A is in a position to view this information directly on the CTI pane 100.

If the user U is already known to the call center, the information sheet for that user is already stored in a customer database 76. Under such circumstances, during the customer information sheet retrieval step E6, the application server 1 obtains the information sheet by requesting it from the customer database 76 using the telephone number of the user U with whom the telesales advisor A is communicating, obtained by means of the event translation (T-Server) module 72. The application server 1 is then responsible for sending the customer information sheet to the telesales advisor A via the CTI pane 100.

If there is no information sheet corresponding to the telephone number obtained in this way, the telesales advisor A can create a new customer information sheet directly from the CTI pane 100 on their CTI station 4 by filling in the second field 100 manually (name, telephone number, postal address of the user with whom they are communicating).

During the telephone conversation, the telesales advisor A advises the user U orally of a list of goods for sale that may be of interest to the user U displayed in the third field 105 of the CTI pane 100.

As a function of the instructions of the user U during the telephone conversation, the telesales advisor A selects from the goods in the list displayed on the CTI pane 100 those that the user U wishes to purchase, to put together a purchase list specific to that user. To simplify putting together the purchase list, the second field 104 of the CTI pane 100 includes selection elements which the telesales advisor can click on or touch, for example, to select a good that the user wishes to purchase.

As soon as the purchase list has been put together, it is stored in a context memory 12 during a second storage step E8 so that a record can be kept of the goods that the user wishes to purchase. The context memory 12 is represented here by way of example as forming an integral part of the application server 1, but can obviously be located remotely of the application server 1. The context memory 12 therefore keeps a trace of goods sold by each telesales advisor and goods purchased by each user.

At the end of the conversation, the telesales advisor A asks the user U if they wish to move on to the purchase confirmation phase (test step E10). If the response is negative, i.e. if the user wishes to abort the purchase, the telesales advisor hangs up, which terminates the recording of the conversation and the call between the user and the telesales advisor is cleared down (final step E24). An intelligent network call routing service protocol (CRSP) module 5 is provided at a stream break position between the intelligent network 8 and the CTI server 7 for clearing down the call and thereby releasing the resources of the call center as soon as the telesales advisor or the user hangs up.

Recording is automatically stopped at the end of the conversation by invoking the “StopEnreg” function of the recording server 50, following detection of the “EventReleased” event produced by the event translation module 72 when the telesales advisor hangs up.

It should nevertheless be noted that if, during the conversation, the user informs the telesales advisor that they do not want the conversation to be recorded, the telesales advisor can manually stop recording the conversation at any time. Under such circumstances, the “StopEnregOnDemand” function is executed.

If the conversation is recorded and if, at the end of the conversation, a sale has been agreed with the telesales advisor and the user wishes to proceed to confirmation of the purchase (positive result of test step E10), the recording of the conversation can be marked during a marking step E11 to retain a record of the intent to purchase of the user U. To this end, from the CTI pane 100, the telesales advisor A commands execution of the “TagVente” function on the application server 1. The effect of this function is to associate an identifying tag with the recorded conversation, which is stored temporarily in the context memory 12.

After the user U has agreed orally for the telesales advisor A to proceed to confirmation of the purchase, the user is connected to the interactive voice server 3. To this end, the telesales advisor A transfers the call in progress to the interactive voice server 3 during a transfer step E12, so that the user is connected transparently to the interactive voice server 3.

The telesales advisor can in particular activate the “Customer Consent” button 107 on the CTI pane 100 to send the interactive voice server 3 a call transfer command on receipt of which the application server 1 executes “UpdateUserData” and “SingleStepTransfer” functions in order to operate on the call in progress.

During an attachment sub-step E120, the list of purchases is sent with the call when it is transferred. This list includes order information relating to the goods that the user ordered beforehand from the telesales advisor. This information includes the reference and the price of each of the goods for which the user is ready to give a formal consent to purchase. In this example, the application server 1 executes an “UpdateUserData” function which attaches to the call, by way of call data, control information contained in the purchase list. During a routing sub-step E122, the current call between the telesales advisor A and the user U of the terminal 6 is routed to the interactive voice server 3. To this end, the application server 1 executes a “SingleStepTransfer” function and on completion of execution of this function the user U of the terminal 6 is connected to the interactive voice server 3 and no longer connected to the telesales advisor A.

During a consent request step E14, the interactive voice server 3 sends the terminal 6 of the user U a consent request message relating to the purchase of the goods according to the order information.

For example, this consent request message comprises an audio message describing the goods ordered by the user. The audio message can be generated during a generation sub-step E140 by a voice synthesis module (not shown) of the interactive voice server 3 from order information supplied beforehand to the interactive voice server 3 during the attachment sub-step E120.

In a different embodiment, an audio sequence for each good available for sale is stored beforehand in a product database and the interactive voice server 3 is responsible for recovering the audio sequences for the goods that the user has ordered.

During a reading sub-step E142, the interactive voice server 3 executes a “Play Announcement” function that reads the audio message out to the user of the terminal 6, reminding them orally of the description of the good they have ordered.

During an options offering sub-step E146, the interactive voice server 3 offers the user various options to guide them through providing the interactive voice server 3 with a consent response. These options can be presented in the form of a voice message to which the user can respond by pressing keys on their terminal 6, for example.

In different embodiments, the user of the terminal 6 can respond to this consent request by using vocal keywords or any other means available to the user on their terminal 6 for selecting options.

For example, the interactive voice server 3 invites the user U of the terminal 6 to use a predefined menu of options on the interactive voice server 3 accessible from the terminal 6 of the user. During the option offering sub-step E146, the interactive voice server 3 presents the options available to the user for the possible responses. For example, the main welcome voice message invites the user 6 to press:
the “2” key on their terminal to confirm purchase of the goods described during the preceding reading sub-step E142;
the “3” key to listen again to the telephone conversation that they had with the telesales advisor beforehand;
the “4” key to receive a confirmation of their purchase on one or more media of their choice, such as paper mail, email, facsimile (fax), text (SMS) message;
the “9” key to be automatically reconnected to the telesales advisor.

If the user U presses the “2” key on their terminal 6 and a purchase event is ready to be transferred (positive result in test step E18) to the customer database 76, pressing the “2” key (the response of the user U) is then detected by a “Collect Digit” function executed in the interactive voice server 3. That response is then stored in association with the list of purchases in the customer database 76 during a storage step E20.

This response advantageously constitutes a proof of consent that confirms that the user U has confirmed the purchase of the goods listed in the list of purchases. This is a positive response to the consent request message sent by the interactive voice server 3. This proof is put into archive storage in the customer database 76 in association with the list of purchases and where applicable with the previously recorded telephone conversation. Once this proof has been obtained and stored in the customer database 76, the purchase of the associated goods is considered to have been confirmed (purchase confirmation step E22). This terminates the method of the invention and the call between the user U and the telesales advisor is cleared down during a final step E24.

If the user presses the “3” key on their terminal in response to the main welcome voice message, then during a conversation listening step E30 the interactive voice server 3 has the user U listen again to the conversation that they previously had with the telesales advisor A, which is stored in the context memory 12. If several conversations have already taken place between the user U and the telesales advisor A, the interactive voice server 3 prompts the user to switch from one conversation to another, in particular by pressing keys on their terminal: for example by pressing the “5” key to go to the previous conversation and the “6” key to go to the next conversation. After they have listened to one or more conversations again, the interactive voice server returns the user to the main welcome voice message and the user is invited to choose a response during the response step E16.

If the user presses the “4” key on their terminal 6 in response to the main welcome voice message, a menu of options of the interactive voice server 3 offers the user U a set of media (email, fax, post) for sending confirmation of their purchase. Confirmation is effective following the response of the customer by signed paper mail, encrypted electronic mail, signed facsimile, etc. Via their terminal 6, the user can then select by which medium they wish to receive the confirmation of their purchase. During a confirmation sending step E26, the interactive voice server 3 sends the purchase confirmation on the medium selected by the user. If there is a purchase event to be processed (positive result in test step E18), then the steps E20, E22 and E24 as described above are chained.

If the user has any doubts regarding their purchase and wishes to talk to the telesales advisor A again, they press the “9” key on their terminal 3, for example, in response to the main welcome voice message, which automatically connects the user U to the telesales advisor A with whom they previously placed their order. For this purpose, during a call transfer step E28, the interactive voice server 3 routes the call in progress to the CTI station 4 of the telesales adviser A by executing a “TRoute” function and using information stored in the context memory 12 (list of goods ordered by user, user and telesales advisor identification data). In this way, the telesales advisor sees on their CTI pane the context of the sale previously agreed with the user.

In the event of non response (step E27) by the user to the options offered by the interactive voice server 3 during the step E16, the interactive voice server 3 re-reads the main welcome message to the user. This occurs if the user does not press any key on their terminal or makes an inappropriate response, i.e. presses a key that is not one of the predefined keys in the menu of options of the interactive voice server 3. If the user does not respond again, the interactive voice server considers that the order or purchase has not been confirmed and transfers the user to the telesales advisor by setting up a new telephone call using the data stored in the context memory 12 by means of the transfer step E28 described above.

Setting up the call between the user and the telesales advisor again automatically in the event of failure by the user to confirm the purchase improves the interactivity between the user U and the telesales advisor A and helps to improve sales effected via a call center.

How the user U of the terminal 6 scans the menu of options of the interactive voice server 3 is advantageously stored in the context memory 12. In this way, the operator of the call center is in a position to know if a sale has been concluded and, if not, at which stage of the process the sale failed. In particular, they can find out if the user refused to give their consent during the consent request step E16.

1. A method of managing calls between a user (U) of a terminal (6), an interactive voice server (3), and an agent (A) of a computer-telephone interconnection (CTI) station (4) via routing means (2, 70) in a telecommunications network (8), in which method the agent (A) obtains order information from the user relating to the purchase of at least one good or service during a call in progress previously set up during a step (E2) of connection of the user (U) and the agent (A) by said routing means, said method comprising the steps of:
(a) the routing means transferring the call in progress to connect the user (U) with the interactive voice server (3);
(b) during a storage step (E8), said order information is stored in a context memory (12);
wherein said call transferring step (E12) comprises:
a sub-step (E120) of attaching said order information to the call in progress; and
a sub-step (E122) of routing the call in progress to the interactive voice server (3);
(c) requesting consent to the purchase of said good or service, comprising:
a sub-step (E140) of the interactive voice server (3) generating a consent request message as a function of said order information; and
a sub-step (E142; E16) of the interactive voice server (3) supplying said consent request message to the terminal (6) of the user so that the purchase of said good or service is confirmed in the event of a positive response by the user (U) on reception by the interactive voice server (3) of a consent response message sent from the terminal (6), the response message being stored in a customer database (76) during a storage step (E20) in association with order information previously stored in the context memory (12); and
(d) if there is no response or a negative response from the user (U) to said consent request message, the call set up at the end of the transfer step (E12) between the interactive voice server (3) and the user (U) is automatically transferred during a call transfer step (E28) to the CTI station (4) of the agent on the basis of order information stored in the context memory (12) to put the user (U) in direct communication with the agent (A).

2. The method according to claim 1, further comprising a storage step (E4) during which the conversation between the user and the agent is stored in the context memory (12).

3. The method according to claim 1, wherein during an option supply step (E146), the interactive voice server (3) offers the user (U) of the terminal (6) a plurality of predefined options that the user (U) is able to select from their terminal (6) to supply a response message to said consent request message received from the interactive voice server (3).

4. The method according to claim 1, wherein during the consent request message supply sub-step (E142), the interactive voice server (3) reads the order information (10) obtained during said attachment sub-step (E120).

5. A system for managing calls between a user (U) of a terminal (6), an interactive voice server (3), and an agent (A) of a computer-telephone interconnection (CTI) station (4) via routing means (2, 70) in a telecommunications network (8), wherein the agent (A) obtains order information from the user relating to the purchase of a good or service during a call in progress previously set up by said routing means during a step E2 of connecting the user (U) and the agent (A), wherein the system comprises:
means (1) for transferring the call in progress to connect the user (U) and the interactive voice server (3);
means (1) for supplying said order information to the interactive voice server (3);
a context memory (12) adapted to store the order information;
means (1) for attaching said order information to the call in progress that is to be routed to the interactive voice server (3) by the routing means (1);
means for requesting consent to the purchase of said good or service, comprising means (3) for generating a consent request message as a function of the order information; and
means (3) for supplying a consent request message to the terminal (6) of the user so that the purchase of said good or service is confirmed on reception by the interactive voice server (3) of a consent response message sent from the terminal (6) if there is a positive response by the user (U); the system further includes routing means adapted, in the event of no response or a negative response from the user (U) to said consent request message, to transfer the call set up between the interactive voice service (3) and the user (U) automatically to the CTI station (4) of the agent (A) to put the user (U) in direct communication with the agent (A).

6. The system according to claim 5, further comprising recording means (50, 51, 12) for recording the conversation between the user (U) and the agent (A).

7. The system according to claim 5, wherein the interactive voice server (3) includes means for offering predefined options that the user (U) is able to select from their terminal (6) to supply a response message to the consent request message received from the interactive voice server (3).

8. The system according to claim 4, wherein the interactive voice server (3) includes means for sending the order information to the terminal (6) of the user (U) vocally.

9. An interactive voice server (3) accessible via a telecommunications network (8), comprising:
means for generating a consent request message as a function of order information received at said server (3), said order information relating to the purchase of at least one good or service and being provided by means of a terminal (6);
means for supplying said consent request message to said terminal (6); and
means for confirming the purchase of said good or service, on reception of a consent response message sent from the terminal (6).
